(19) United States
(12) Patent Application Publication
(10) Pub. No.: US 2020/0236269 A1
(43) Pub. Date: Jul. 23, 2020

(54) DYNAMIC EXPOSURE FOR AUTOFOCUS IN LOW LIGHT

(71) Applicant: QUALCOMM Incorporated, San Diego, CA (US)

(72) Inventors: Soman Ganesh Nikhara, Hyderabad (IN); Ravi Shankar Kadambala, Hyderabad (IN); Bapineedu Chowdary Gummadi, Hyderabad (IN); Ankita Anil Kumar Choudha, Hyderabad (IN)

(21) Appl. No.: 16/255,404

(22) Filed: Jan. 23, 2019

(51) Int. Cl. H04N 5/235; H04N 5/232; G03B 13/36

(52) U.S. Cl. CPC H04N 5/2353; H04N 5/2351; H04N 5/23245; G03B 13/36; H04N 5/232122

(57) ABSTRACT

Methods, systems, and devices for image processing are described. The method includes using exposure control processes to set an exposure length for a set of one or more image pixels of a sensor, determining a light level of an environment of the sensor and a confidence level associated with a set of one or more autofocus pixels of the sensor, selecting one of a first exposure control process or a second exposure control process for the set of one or more autofocus pixels of the sensor, where the selection is based on the light level and the confidence level, performing an autofocus operation for the sensor based on an output of the one or more autofocus pixels and the selected one of the first or the second exposure control process, and outputting image data from the one or more image pixels of the sensor based on the autofocus operation.

### BACKGROUND

The following relates generally to image processing, and more specifically to dynamic autofocus exposure for low light conditions.

Autofocus may refer to a field of image processing for detecting an object in a field of view of an image sensor and using motors or digital processing to focus the sensor on the detected object. Many image sensors include autofocus pixels in addition to image pixels. The autofocus pixels are used for autofocus operations and the image pixels output the image captured by the sensor. Autofocus operations using autofocus pixels are traditionally considered to be less reliable in low light conditions due to higher amounts of optical noise. devices may benefit from improved autofocus techniques to improve the reliability of pixel-based autofocus in low light conditions.

### SUMMARY

The described techniques relate to improved methods, systems, devices, and apparatuses that support dynamic autofocus exposure in low light conditions. Generally, the described techniques provide for improving exposure settings for autofocus in low light by providing separate, dynamically selected exposure settings for image pixels and autofocus pixels in an image sensor.

A method of image processing at a device is described. The method may include using a first exposure control process to set an exposure length for a set of one or more image pixels of a sensor, determining a light level of an environment of the sensor and a confidence level associated with a set of one or more autofocus pixels of the sensor, selecting one of the first exposure control process or a second exposure control process for the set of one or more autofocus pixels of the sensor, where the selection is based on the light level and the confidence level, performing an autofocus operation for the sensor based on an output of the autofocus pixels and the selected one of the first exposure control process or the second exposure control process, and outputting image data from the image pixels of the sensor based on the autofocus operation.

An apparatus for image processing at a device is described. The apparatus may include a processor, memory in electronic communication with the processor, and instructions stored in the memory. The instructions may be executable by the processor to cause the apparatus to use a first exposure control process to set an exposure length for a set of one or more image pixels of a sensor, determine a light level of an environment of the sensor and a confidence level associated with a set of one or more autofocus pixels of the sensor, select one of the first exposure control process or a second exposure control process for the set of one or more autofocus pixels of the sensor, where the selection is based on the light level and the confidence level, perform an autofocus operation for the sensor based on an output of the autofocus pixels and the selected one of the first exposure control process or the second exposure control process, and output image data from the image pixels of the sensor based on the autofocus operation.

Another apparatus for image processing at a device is described. The apparatus may include means for using a first exposure control process to set an exposure length for a set of one or more image pixels of a sensor, determining a light level of an environment of the sensor and a confidence level associated with a set of one or more autofocus pixels of the sensor, selecting one of the first exposure control process or a second exposure control process for the set of one or more autofocus pixels of the sensor, where the selection is based on the light level and the confidence level, performing an autofocus operation for the sensor based on an output of the autofocus pixels and the selected one of the first exposure control process or the second exposure control process, and outputting image data from the image pixels of the sensor based on the autofocus operation.

A non-transitory computer-readable medium storing code for image processing at a device is described. The code may include instructions executable by a processor to use a first exposure control process to set an exposure length for a set of one or more image pixels of a sensor, determine a light level of an environment of the sensor and a confidence level associated with a set of one or more autofocus pixels of the sensor, select one of the first exposure control process or a second exposure control process for the set of one or more autofocus pixels of the sensor, where the selection is based on the light level and the confidence level, perform an autofocus operation for the sensor based on an output of the autofocus pixels and the selected one of the first exposure control process or the second exposure control process, and output image data from the image pixels of the sensor based on the autofocus operation.

Some examples of the method, apparatuses, and non-transitory computer-readable medium described herein may further include operations, features, means, or instructions for selecting the first exposure control process for both the set of one or more image pixels and the set of one or more autofocus pixels when the determined light level satisfies the light level threshold and when the confidence level satisfies the confidence level threshold.

Some examples of the method, apparatuses, and non-transitory computer-readable medium described herein may further include operations, features, means, or instructions for selecting the first exposure control process for the image pixels and the second exposure control process for the autofocus pixel(s) when either the determined light level fails to satisfy the light level threshold or when the confidence level fails to satisfy the confidence level threshold.

Some examples of the method, apparatuses, and non-transitory computer-readable medium described herein may further include operations, features, means, or instructions for using a first rolling shutter to sense one or more frames for the set of one or more image pixels and a second rolling shutter to sense one or more frames for the set of one or more autofocus pixels when either the determined light level fails to satisfy the light level threshold or when the confidence level fails to satisfy the confidence level threshold.

Some examples of the method, apparatuses, and non-transitory computer-readable medium described herein may further include operations, features, means, or instructions for using the first rolling shutter to sense one or more frames for the autofocus pixel(s) and sense one or more frames for the set of one or more image pixels when the determined light level satisfies the light level threshold and when the confidence level satisfies the confidence level threshold.

Some examples of the method, apparatuses, and non-transitory computer-readable medium described herein may further include operations, features, means, or instructions for using the first rolling shutter to sense two frames for the set of one or more autofocus pixels.

Some examples of the method, apparatuses, and non-transitory computer-readable medium described herein may further include operations, features, means, or instructions for stacking two or more frames sensed by the first rolling shutter to increase an amount of light information available for the autofocus operation.

### BRIEF DESCRIPTION OF THE DRAWINGS

FIG. 1 illustrates an example of a system for image processing that supports dynamic autofocus exposure in low light in accordance with aspects of the present disclosure.

FIGS. 2 and 3 show flowcharts illustrating methods that support dynamic autofocus exposure in low light conditions in accordance with aspects of the present disclosure.

FIGS. 4 and 5 show block diagrams of devices that support dynamic autofocus exposure in low light conditions in accordance with aspects of the present disclosure.

FIG. 6 shows a block diagram of an image processing manager that supports dynamic autofocus exposure in low light conditions in accordance with aspects of the present disclosure.

FIG. 7 shows a diagram of a system including a device that supports dynamic autofocus exposure in low light conditions in accordance with aspects of the present disclosure.

FIGS. 8 and 9 show flowcharts illustrating methods that support dynamic autofocus exposure in low light conditions in accordance with aspects of the present disclosure.

### DETAILED DESCRIPTION

Some electronic devices may include a camera or other image sensor that supports autofocus and zoom features. For example, a camera supporting an autofocus feature may include image pixels and autofocus pixels, such as phase-detected autofocus (PDAF) pixels. Conventionally, PDAF pixels and image pixels may share the same configuration for pixel readout, exposure, and light sensitivity. In some cases, autofocus (e.g., PDAF, etc.) may perform well in normal or sufficient lighting conditions. In some cases, the same single exposure configuration may be used for the autofocus pixels and the image pixels both in normal lighting conditions as well as low light conditions. Sharing this same configuration allows autofocus processing to autofocus an image in well-lit environments where there is sufficient light. In some cases, a camera may gather a first set of pixels for autofocus and a second set of pixels for capturing images. However, using the same single exposure configuration for autofocus pixels and image pixels may result in autofocus failing to accurately focus on an object in view of the camera. For example, in low light conditions (e.g., night time outdoors, a dark room indoors, etc.), autofocus may perform poorly due to the lack of light resulting in a low signal to noise ratio. In some cases, the shared configuration does not work well in low light conditions due to the higher noise inherent in low light conditions. As a result, under certain low light conditions the autofocus pixels may have a significantly lower signal to noise ratio (SNR) compared to autofocus pixels captured in sufficiently-lit environments. In some cases, a low SNR in the autofocus pixels may result in the autofocus process (e.g., PDAF process) failing to provide reliable autofocus. In some cases, when the autofocus process fails to provide reliable autofocus, an alternative autofocus process may be implemented (e.g., contrast autofocus, laser autofocus, etc.), resulting in an increase to an overall latency associated with the autofocus process.

The present techniques provide dynamic exposure configuration associated with an autofocus process. In some cases, the present techniques may include enabling a separate exposure control mechanism for autofocus processing based on a measure of light and/or a confidence level. For example, the present techniques may support a second exposure configuration for autofocus pixels (e.g., PDAF pixels) separate and different from a first exposure configuration. For example, the present techniques may include using a first exposure configuration for image pixels and autofocus pixels when sufficient light is present. When sufficient light is not present, the present techniques may include using the first exposure configuration to capture image pixels, and using the second exposure configuration to capture autofocus pixels.

In one example, the present techniques may implement a dynamic rolling shutter. A rolling shutter may include an image sensor with multiple rows of sensor elements and/or multiple columns of sensor elements. In some examples, the rolling shutter may capture one or more images (e.g., one or more still photograph images, a stream of video images, etc.) by scanning across a scene either vertically (e.g., row by row of sensor elements) or horizontally (e.g., column by column of sensor elements). For example, the rolling shutter may capture a first row of pixels from a first row of sensor elements, then capture a second row of pixels from a second row of sensor elements, and so on. In some cases, the present techniques may implement a first rolling shutter to sense frames for image processing and a second rolling shutter to sense frames for autofocus processing (e.g., PDAF processing). Alternatively, the present techniques may include using the same rolling shutter to sense frames for both autofocus processing and image processing. In some cases, when using the same rolling shutter the autofocus process of the present techniques may include capturing multiple autofocus frames, stacking at least two of the multiple captured autofocus frames, and processing the stack of at least two frames to increase an amount of light information available for autofocus processing. Stacking frames is performed to increase a signal to noise ratio (SNR) and to increase a dynamic range of the captured view. Stacking frames includes capturing two or more frames and then programmatically overlaying the multiple frames into one multi-layered image. Each captured frame includes an image with multiple pixels and each pixel records a signal as well as noise. However, while the signal value remains the same for a particular pixel across multiple captured frames, the noise value for that particular pixel varies in each captured frame. Moreover, when multiple frames are combined into one multi-layered frame, the averaged noise per pixel converges to zero, while the averaged signal per pixel converges to the actual value of the signal. Accordingly, stacking multiple frames is a pixel-by-pixel operation that removes noise from each pixel of the multiple frames, producing a combined frame with a higher SNR than any of the individually captured frames.

Aspects of the disclosure are initially described in the context of digital images (e.g., one or more images, an image stream, etc.) and process flows related to dynamic exposure configuration. Aspects of the disclosure are further illustrated by and described with reference to apparatus diagrams, system diagrams, and flowcharts that relate to enhancing dynamic exposure configuration in accordance with the present techniques.

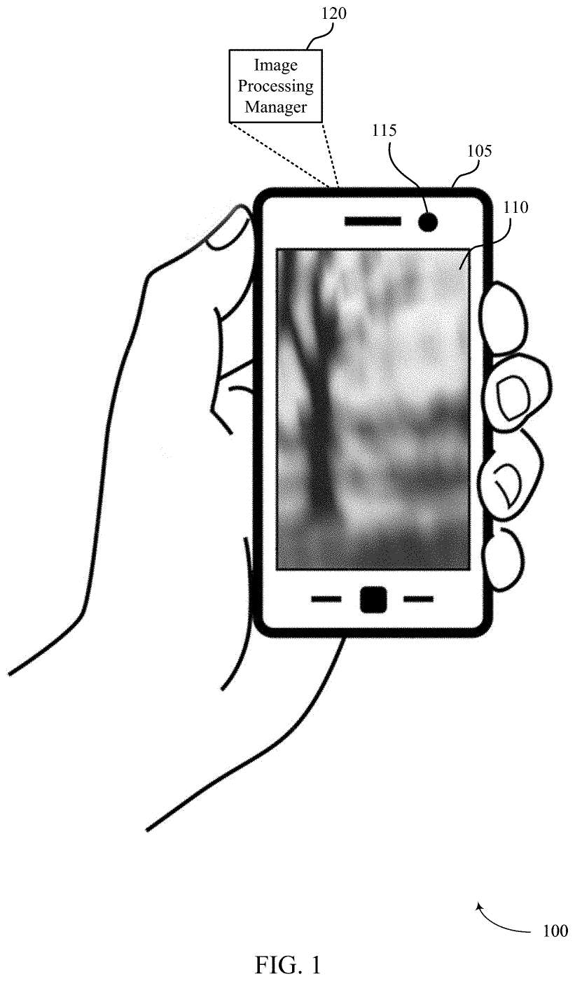

FIG. 1 illustrates an example of a digital image system 100 that supports dynamic exposure for autofocus in low light conditions in accordance with aspects of the present disclosure. As shown, digital image system 100 may include device 105. In the illustrated example, device 105 may include a display 110. In some cases, device 105 may include a camera 115 for capturing still images and/or video images. In some cases, camera 115 may include a front-facing camera as shown. In some cases, device 105 may also include a rear-facing camera. In one example, device 105 may capture images by an image sensor of camera 115 on device 105 that is interoperable with a processor of device 105 capable of implementing aspects of the present disclosure. Additionally or alternatively, digital image system 100 may be obtained by a device (e.g., a wireless device) via a transmission received from another device (e.g., over a wireless link, a wired link, a portable memory, etc.). As shown, display 110 may display pictures captured by camera 115 on device 105, and/or a camera wireless connected to device 105. In some cases, display 110 may display stacked images captured by camera 115 (e.g., one or more image frames stacked and displayed on display 110).

Although reference is made to camera 115, it is understood that the description of camera 115 applies to a front-facing camera of device 105 and/or a rear-facing camera of device 105. In some examples, camera 115 may include one or more autofocus motors to adjust the focus of images captured by the one or more cameras. In one example, camera 115 may include one or more adjustable lens elements. In some cases, camera 115 may include one or more adjustable image sensors. In some cases, camera 115 may include an autofocus motor to adjust at least one adjustable lens element of camera 115. Additionally or alternatively, camera 115 may include an autofocus motor to adjust at least one adjustable image sensor.

As shown, device 105 may include an autofocus manager 120. Aspects of the present disclosure relate to autofocus manager enabling improved techniques for autofocus when camera 115 is used in well-lit conditions (e.g., sufficient lighting conditions for using a single exposure configuration for image processing and PDAF processing) and when used with low light conditions (e.g., insufficient lighting conditions for using a single exposure configuration for image processing and PDAF processing). For example, autofocus manager 120 may determine a light level of an environment of a sensor of camera 115 and/or a confidence level associated with a set of one or more autofocus pixels of the sensor of camera 115. In some cases, autofocus manager 120 may use a first exposure control process to set an exposure length for a set of one or more image pixels of the sensor of camera 115 independent of the determined light level and/or confidence level.

In some examples, autofocus manager 120 may select the first exposure control process or a second exposure control process for the set of one or more autofocus pixels based at least in part on the determined light level and/or the confidence level. For example, when the determined light level drops below a light level threshold (e.g., is at or below a light level threshold), autofocus manager 120 may use the second exposure control process for the set of one or more autofocus pixels and use the first exposure control process for the set of one or more image pixels.

Alternatively, when the determined light level is above a light level threshold (e.g., is at or above a light level threshold), autofocus manager 120 may use the first exposure control process for both the set of one or more autofocus pixels and the set of one or more image pixels. In some cases, autofocus manager 120 may perform an autofocus operation for the sensor of camera 115 based at least in part on an output of the autofocus pixels and the selected one of the first exposure control process or the second exposure control process. In some examples, autofocus manager 120 may output image data from the image pixels of the sensor based at least in part on the autofocus operation.

The present techniques result in an increased autofocus signal to noise ratio (SNR) in low light conditions, improving the autofocus accuracy and reliability. For example, the present techniques (e.g., operations of autofocus manager 120, etc.), resolve the low light limitations of conventional PDAF solutions by providing dynamically selective autofocus exposure settings for low light conditions and sufficient light conditions. Furthermore, the present techniques reduce snapshot latency. For example, conventional autofocus solutions may provide a default autofocus process (e.g., phase detection autofocus) as well as one or more backup autofocus processes (e.g., contrast autofocus, laser autofocus, etc.). In the conventional system, the camera may switch from the default autofocus process to a backup autofocus process. However, switching from one autofocus process to another autofocus process takes times, thus increasing the autofocus latency. However, the present techniques uses a single autofocus process and dynamically modifies the settings of the single autofocus process, which takes considerably less time than switching from a default autofocus process to a backup autofocus process. Accordingly, the present techniques reduce the snapshot latency.

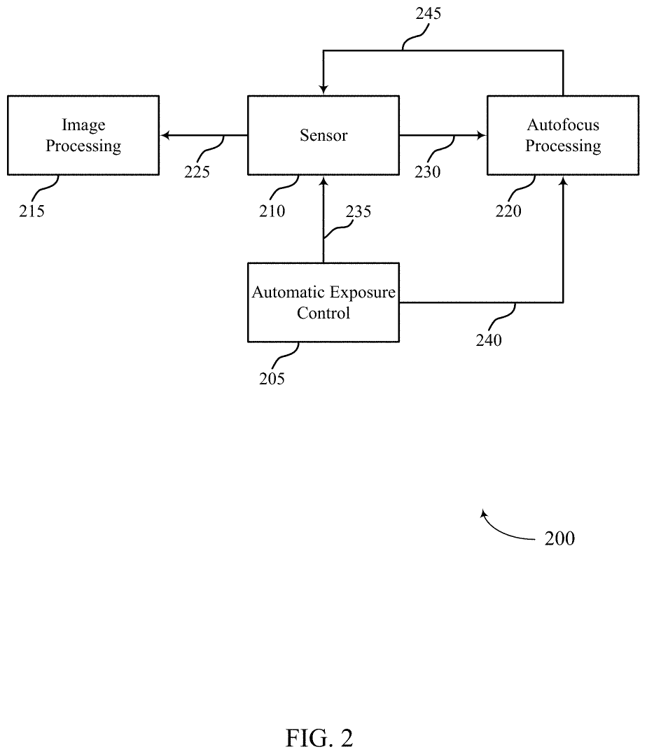

FIG. 2 an example of a process flow 200 that supports dynamic exposure for autofocus in low light conditions in accordance with aspects of the present disclosure. In some examples, process flow 200 may in some cases be performed by a device performing the processing operations described with reference to digital image system 100 (e.g., at least one processor of device 105, autofocus manager 120, etc.). Additionally or alternatively, process flow 200 may be performed by a remote device (e.g., a server, a remote image device, a remote computing device, or the like), and the output of process flow 200 may be communicated to a local device (e.g., to device 105 via a wireless link, via a non-transitory computer readable medium, or the like). As shown, process flow 200 may include automatic exposure control 205, at least one sensor 210 (e.g., sensor of camera 115), image processing 215, and autofocus processing 220 (e.g., phase detection autofocus processing).

In some cases, automatic exposure control 205 may perform one or more exposure control operations. In some cases, the one or more exposure control operations may include determining a light level. In some examples, the one or more exposure control operations may include determining whether the determined light level exceeds a set light level threshold. Additionally or alternatively, the one or more exposure control operations may include determining a confidence level. In some examples, the one or more exposure control operations may include determining whether the determined confidence level exceeds a set confidence level threshold.

In some cases, sensor 210 may capture image data and autofocus data. At 225, sensor 210 may send the captured image data to image processing 215. In some cases, the captured image data of 225 may include one or more frames of image pixels sensed by sensor 210. At 230, sensor 210 may send the captured autofocus data to autofocus processing 220. In some cases, the captured autofocus data of 230 may include one or more frames of autofocus pixels (e.g., non-stacked frames of autofocus pixels, stacked frames of autofocus pixels, etc.). In some cases, image processing 215 may be performed by one or more image processors, and autofocus processing 220 may be performed by one or more autofocus processors. In some cases, each of the one or more image processors of image processing 215 may be different from the one or more autofocus processors of autofocus processing 220. Alternatively, at least one processor of the one or more image processors of image processing 215 may be a processor from the one or more autofocus processors of autofocus processing 220.

At 235, automatic exposure control 205 may send image exposure data to sensor 210. In some cases, the image exposure data of 235 may be based at least in part on the one or more exposure control operations performed by automatic exposure control 205 (e.g., based at least in part on the determined light level and/or the determined confidence level). In some cases, the image data sent by image sensor 210 at 225 may be generated based at least in part on the image exposure data of 235. For example, the image exposure data of 235 may include an exposure configuration instructing sensor 210 how to capture one or more frames of image pixels (e.g., exposure time, an aperture setting of sensor 210, a set sensitivity level of sensor 210, a shutter speed of sensor 210, etc.).

At 240, automatic exposure control 205 may send autofocus exposure data to autofocus processing 220. In some cases, the autofocus exposure data of 240 may be based at least in part on the one or more exposure control operations performed by automatic exposure control 205 (e.g., based at least in part on the determined light level and/or the determined confidence level).

At 245, autofocus processing 220 may send autofocus exposure configuration data to sensor 210. In some cases, the autofocus exposure configuration data may include exposure settings for frames of autofocus pixels. In some cases, the autofocus data sent by image sensor 210 at 230 may be generated based at least in part on the autofocus exposure data of 240. For example, the autofocus exposure data of 210 may include an exposure configuration instructing sensor 210 how to capture one or more frames of autofocus pixels (e.g., exposure time, an aperture setting of sensor 210, a set sensitivity level of sensor 210, a shutter speed of sensor 210, etc.). In some examples, the autofocus exposure configuration data of 245 may be based at least in part on the autofocus exposure data of 240. Additionally or alternatively, the autofocus exposure configuration data of 245 may be based at least in part on the captured autofocus data of 230. In some cases, autofocus processing 220 may analyze the autofocus exposure data of 240 and/or analyze the captured autofocus data of 230. In one example, autofocus processing 220 may perform one or more autofocus processes where at least one autofocus process performed by autofocus processing 220 is based at least in part on analysis of the autofocus exposure data of 240 and/or the analysis of the captured autofocus data of 230.

In some cases, the captured autofocus data of 230 may be generated based at least in part on the autofocus exposure configuration data of 245. Accordingly, in some cases, the autofocus exposure configuration data of 245 may be form a feedback loop with sensor 210 to enable sensor 210 to modify in real time a stream of autofocus data captured by sensor 210 and outputted as a stream captured autofocus data at 230.

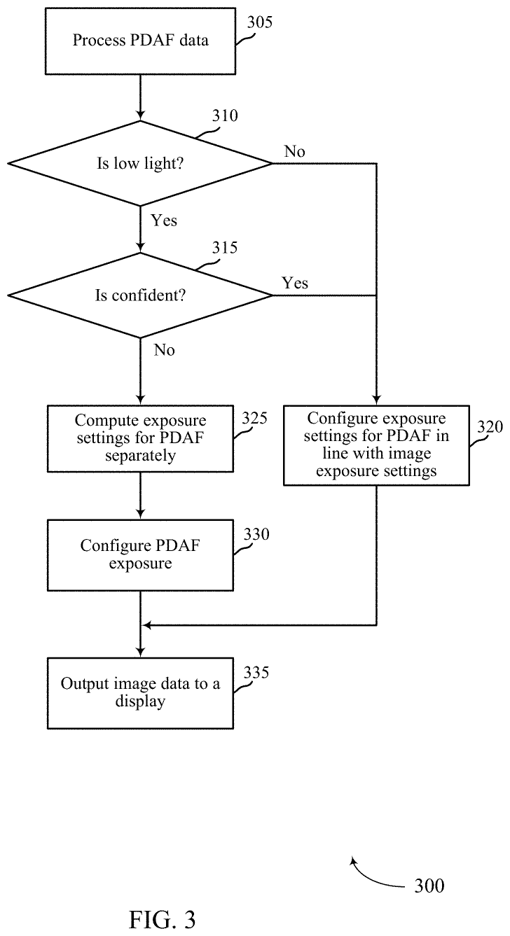

FIG. 3 flowchart illustrating a method 300 that supports dynamic exposure for autofocus in low light conditions in accordance with aspects of the present disclosure. The operations of method 300 may be implemented by a device or its components as described herein. For example, the operations of method 300 may be performed by an autofocus manager as described with reference to FIGS. 1 and 2. In some examples, a device may execute a set of instructions to control the functional elements of the device to perform the functions described below. Additionally or alternatively, a device may perform aspects of the functions described below using special-purpose hardware

At 305, method 300 may include processing phase detection autofocus (PDAF) data. In some cases, the PDAF data may include one or more frames of autofocus pixels captured by an image sensor (e.g., a sensor of camera 115 of FIG. 1, sensor 210 of FIG. 2, etc.). Additionally or alternatively, PDAF data may include a determined light level or a determined confidence level, or both.

At 310, method 300 may include determining whether the determined light level falls below a set low light threshold. Method 300 may perform one or more first operations when the determined light level falls below the low light threshold, and may perform one or more second operations when the determined light level does not fall below the low light threshold.

At 315, method 300 may include determining whether the confidence level falls below a set confidence level threshold when method 300 determines the determined light level falls below the low light threshold. Method 300 may perform one or more first operations when the determined confidence level falls below the confidence level threshold, and may perform one or more second operations when the determined confidence level does not fall below the confidence level threshold.

At 320, when method 300 determines the determined light level does not fall below the low light threshold (e.g., relatively sufficient levels of light) or when method 300 determines the confidence level does not fall below the confidence level threshold (e.g., sufficient confidence), method 300 may include configuring exposure settings for sensing PDAF pixels in line with the exposure settings for sensing image pixels. For example, at 320 method 300 may use the same exposure settings to sense PDAF pixels as used to sense image pixels when there is a relatively sufficient level of light and/or when there is a sufficient confidence level. In some cases, the confidence level may be based at least in part on a signal to noise ratio (SNR). In one example, the higher the SNR the higher the confidence level. Additionally or alternatively, the confidence level may be based at least in part on a PDAF process. In one example, the confidence level may be determined for each window of an image frame for which PDAF processing is performed. In some cases, objects in an image frame that are at certain depths from the camera (e.g., device 105) may be calculated with higher confidence than objects at different depths. In some cases, the confidence level may decrease for areas of the image frame having relatively low contrast (e.g., blue sky, walls of a single color, etc.). In one example, an image frame that does not have any foreground objects within a central portion of the image frame may result in a relatively low confidence level.

At 325, method 300 may include computing an exposure setting for PDAF pixels separately from computing an exposure setting for image pixels.

At 330, method 300 may include configuring a sensor to sense PDAF pixels based at least in part on the exposure settings computed at 325.

At 335, method 300 may include outputting image data to a display of a camera (e.g., display 110 of device 105) based at least on part on the exposure settings of 320 and/or the exposure settings of 330.

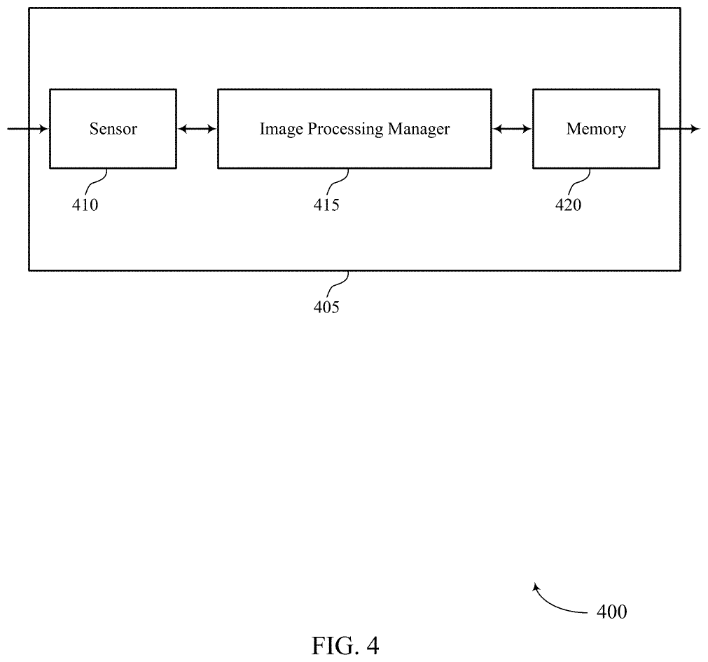

FIG. 4 shows a block diagram 400 of a device 405 that supports dynamic autofocus exposure in low light conditions in accordance with aspects of the present disclosure. The device 405 may be an example of aspects of a device as described herein. The device 405 may include a sensor 410, an image processing manager 415, and a memory 420. The device 405 may also include a processor. Each of these components may be in communication with one another (e.g., via one or more buses).

Sensor 410 may include or be an example of a digital imaging sensor for taking photos and video. In some examples, sensor 410 may receive information such as packets, user data, or control information associated with various information channels. Information may be passed on to other components of the device. Additionally or alternatively, components of device 405 used to communicate data over a wireless (e.g., or wired) link may be in communication with image processing manager 415 (e.g., via one or more buses) without passing information through sensor 410.

The image processing manager 415 may use a first exposure control process to set an exposure length for a set of one or more image pixels of a sensor, determine a light level of an environment of the sensor and a confidence level associated with a set of one or more autofocus pixels of the sensor, select one of the first exposure control process or a second exposure control process for the set of one or more autofocus pixels of the sensor, where the selection is based on the light level and the confidence level, perform an autofocus operation for the sensor based on an output of the autofocus pixels and the selected one of the first exposure control process or the second exposure control process, and output image data from the image pixels of the sensor based on the autofocus operation. The image processing manager 415 may be an example of aspects of the image processing manager 710 described herein.

The image processing manager 415, or its sub-components, may be implemented in hardware, code (e.g., software or firmware) executed by a processor, or any combination thereof. If implemented in code executed by a processor, the functions of the image processing manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The image processing manager 415, or its sub-components, may be physically located at various positions, including being distributed such that portions of functions are implemented at different physical locations by one or more physical components. In some examples, the image processing manager 415, or its sub-components, may be a separate and distinct component in accordance with various aspects of the present disclosure. In some examples, the image processing manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Memory 420 may store information (e.g., facial feature information) generated by other components of the device such as image processing manager 415. For example, memory 420 may store facial feature information with which to compare an output of image processing manager 415. Memory 420 may comprise one or more computer-readable storage media. Examples of memory 420 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., image processing manager 415).

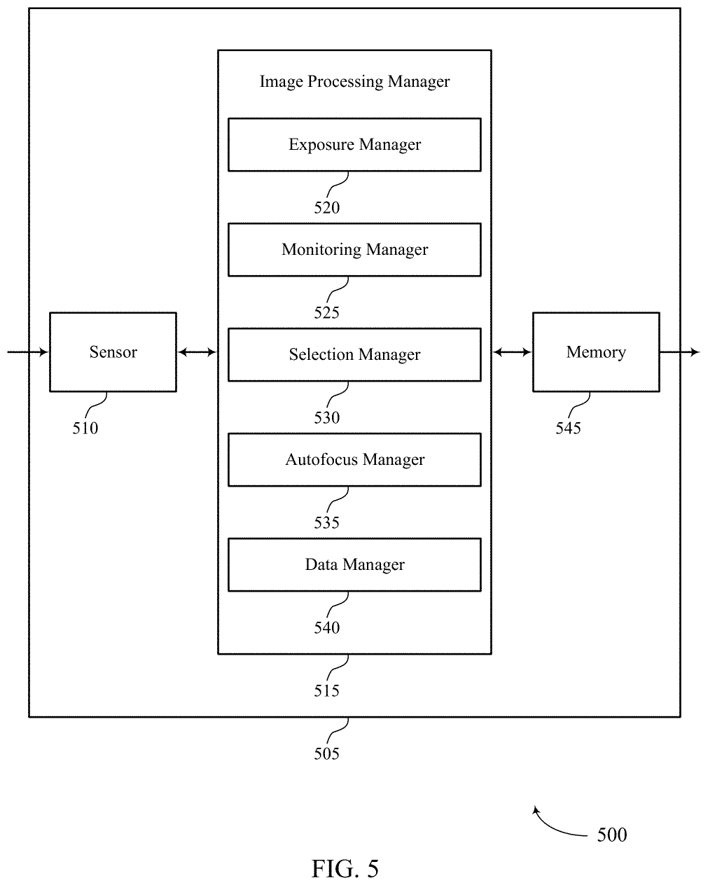

FIG. 5 shows a block diagram 500 of a device 505 that supports dynamic autofocus exposure in low light conditions in accordance with aspects of the present disclosure. The device 505 may be an example of aspects of a device 405 or a camera 115 as described herein. The device 505 may include a sensor 510, an image processing manager 515, and a memory 545. The device 505 may also include a processor. Each of these components may be in communication with one another (e.g., via one or more buses).

Sensor 510 may include or be an example of a digital imaging sensor for taking photos and video. In some examples, sensor 510 may receive information such as packets, user data, or control information associated with various information channels. Information may be passed on to other components of the device. Additionally or alternatively, components of device 505 used to communicate data over a wireless (e.g., or wired) link may be in communication with image processing manager 515 (e.g., via one or more buses) without passing information through sensor 510.

The image processing manager 515 may be an example of aspects of the image processing manager 415 as described herein. The image processing manager 515 may include an exposure manager 520, a monitoring manager 525, a selection manager 530, an autofocus manager 535, and a data manager 540. The image processing manager 515 may be an example of aspects of the image processing manager 710 described herein.

The exposure manager 520 may use a first exposure control process to set an exposure length for a set of one or more image pixels of a sensor. The monitoring manager 525 may determine a light level of an environment of the sensor and a confidence level associated with a set of one or more autofocus pixels of the sensor.

The selection manager 530 may select one of the first exposure control process or a second exposure control process for the set of one or more autofocus pixels of the sensor, where the selection is based on the light level and the confidence level. The autofocus manager 535 may perform an autofocus operation for the sensor based on an output of the autofocus pixels and the selected one of the first exposure control process or the second exposure control process. The data manager 540 may output image data from the image pixels of the sensor based on the autofocus operation.

Memory 545 may store information (e.g., facial feature information) generated by other components of the device such as image processing manager 515. For example, memory 545 may store facial feature information with which to compare an output of image processing manager 515. Memory 545 may comprise one or more computer-readable storage media. Examples of memory 545 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., image processing manager 515).

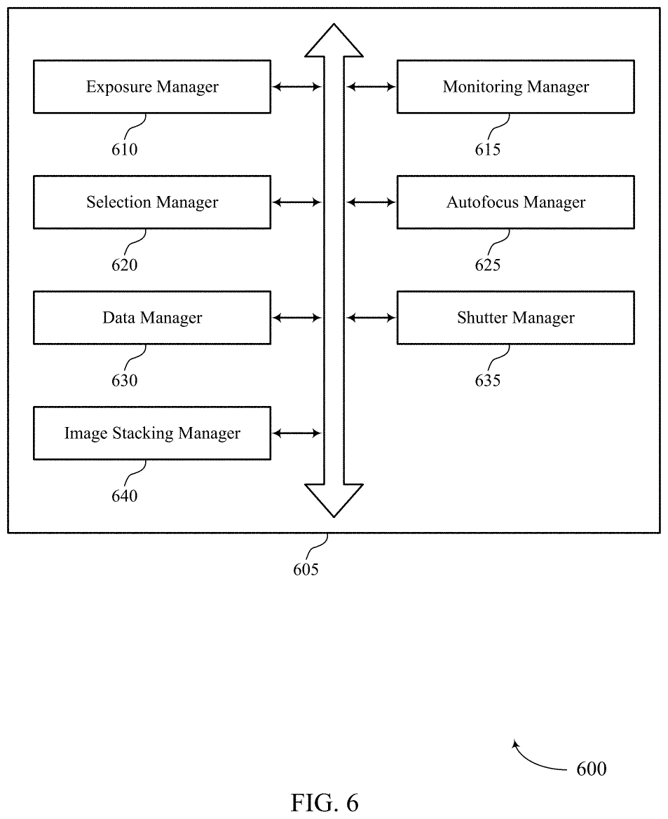

FIG. 6 shows a block diagram 600 of an image processing manager 605 that supports dynamic autofocus exposure in low light conditions in accordance with aspects of the present disclosure. The image processing manager 605 may be an example of aspects of an image processing manager 415, an image processing manager 515, or an image processing manager 710 described herein. The image processing manager 605 may include an exposure manager 610, a monitoring manager 615, a selection manager 620, an autofocus manager 625, a data manager 630, a shutter manager 635, and an image stacking manager 640. Each of these modules may communicate, directly or indirectly, with one another (e.g., via one or more buses).

The exposure manager 610 may use a first exposure control process to set an exposure length for a set of one or more image pixels of a sensor. The monitoring manager 615 may determine a light level of an environment of the sensor and a confidence level associated with a set of one or more autofocus pixels of the sensor.

The selection manager 620 may select one of the first exposure control process or a second exposure control process for the set of one or more autofocus pixels of the sensor, where the selection is based on the light level and the confidence level. In some examples, the selection manager 620 may select the first exposure control process for both the set of one or more image pixels and the set of one or more autofocus pixels when the determined light level satisfies the light level threshold and when the confidence level satisfies the confidence level threshold. In some examples, the selection manager 620 may select the first exposure control process for the image pixels and the second exposure control process for the autofocus pixel(s) when either the determined light level fails to satisfy the light level threshold or when the confidence level fails to satisfy the confidence level threshold.

The autofocus manager 625 may perform an autofocus operation for the sensor based on an output of the autofocus pixels and the selected one of the first exposure control process or the second exposure control process. The data manager 630 may output image data from the image pixels of the sensor based on the autofocus operation. The shutter manager 635 may use a first rolling shutter to sense one or more frames for the set of one or more image pixels and a second rolling shutter to sense one or more frames for the set of one or more autofocus pixels when either the determined light level fails to satisfy the light level threshold or when the confidence level fails to satisfy the confidence level threshold.

In some examples, the shutter manager 635 may use the first rolling shutter to sense one or more frames for the autofocus pixel(s) and sense one or more frames for the set of one or more image pixels when the determined light level satisfies the light level threshold and when the confidence level satisfies the confidence level threshold. In some examples, the shutter manager 635 may use the first rolling shutter to sense two frames for the set of one or more autofocus pixels. The image stacking manager 640 may stack two or more frames sensed by the first rolling shutter to increase an amount of light information available for the autofocus operation.

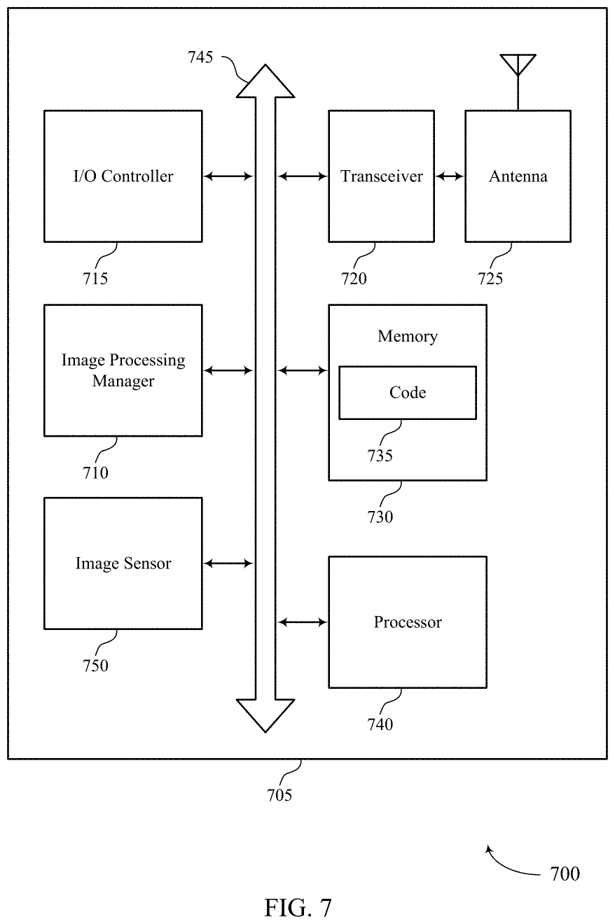

FIG. 7 shows a diagram of a system 700 including a device 705 that supports dynamic autofocus exposure in low light conditions in accordance with aspects of the present disclosure. The device 705 may be an example of or include the components of device 405, device 505, or a device as described herein. The device 705 may include components for bi-directional voice and data communications including components for transmitting and receiving communications, including an image processing manager 710, an I/O controller 715, a transceiver 720, an antenna 725, memory 730, a processor 740, and an image sensor 750. These components may be in electronic communication via one or more buses (e.g., bus 745).

The image processing manager 710 may use a first exposure control process to set an exposure length for a set of one or more image pixels of image sensor 750, determine a light level of an environment of image sensor 750 and a confidence level associated with a set of one or more autofocus pixels of image sensor 750, select one of the first exposure control process or a second exposure control process for the set of one or more autofocus pixels of image sensor 750, where the selection is based on the light level and the confidence level, perform an autofocus operation for image sensor 750 based on an output of the autofocus pixels and the selected one of the first exposure control process or the second exposure control process, and output image data from the image pixels of image sensor 750 based on the autofocus operation.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting dynamic autofocus exposure in low light conditions).

The code 735 may include instructions to implement aspects of the present disclosure, including instructions to support image processing. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

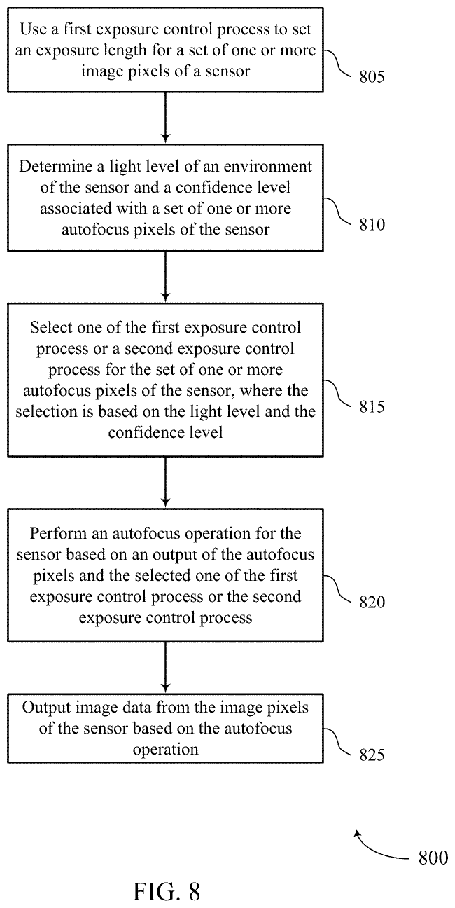

FIG. 8 shows a flowchart illustrating a method 800 that supports dynamic autofocus exposure in low light conditions in accordance with aspects of the present disclosure. The operations of method 800 may be implemented by a device or its components as described herein. For example, the operations of method 800 may be performed by an image processing manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may use a first exposure control process to set an exposure length for a set of one or more image pixels of a sensor (e.g., image sensor 750). The operations of 805 may be performed according to the methods described herein. In some examples, aspects of the operations of 805 may be performed by an exposure manager as described with reference to FIGS. 4 through 7.

At 810, the device may determine a light level of an environment of the sensor and a confidence level associated with a set of one or more autofocus pixels of the sensor. The operations of 810 may be performed according to the methods described herein. In some examples, aspects of the operations of 810 may be performed by a monitoring manager as described with reference to FIGS. 4 through 7.

At 815, the device may select one of the first exposure control process or a second exposure control process for the set of one or more autofocus pixels of the sensor, where the selection is based on the light level and the confidence level. The operations of 815 may be performed according to the methods described herein. In some examples, aspects of the operations of 815 may be performed by a selection manager as described with reference to FIGS. 4 through 7.

At 820, the device may perform an autofocus operation for the sensor based on an output of the autofocus pixels and the selected one of the first exposure control process or the second exposure control process. The operations of 820 may be performed according to the methods described herein. In some examples, aspects of the operations of 820 may be performed by an autofocus manager as described with reference to FIGS. 4 through 7.

At 825, the device may output image data from the image pixels of the sensor based on the autofocus operation. The operations of 825 may be performed according to the methods described herein. In some examples, aspects of the operations of 825 may be performed by a data manager as described with reference to FIGS. 4 through 7.

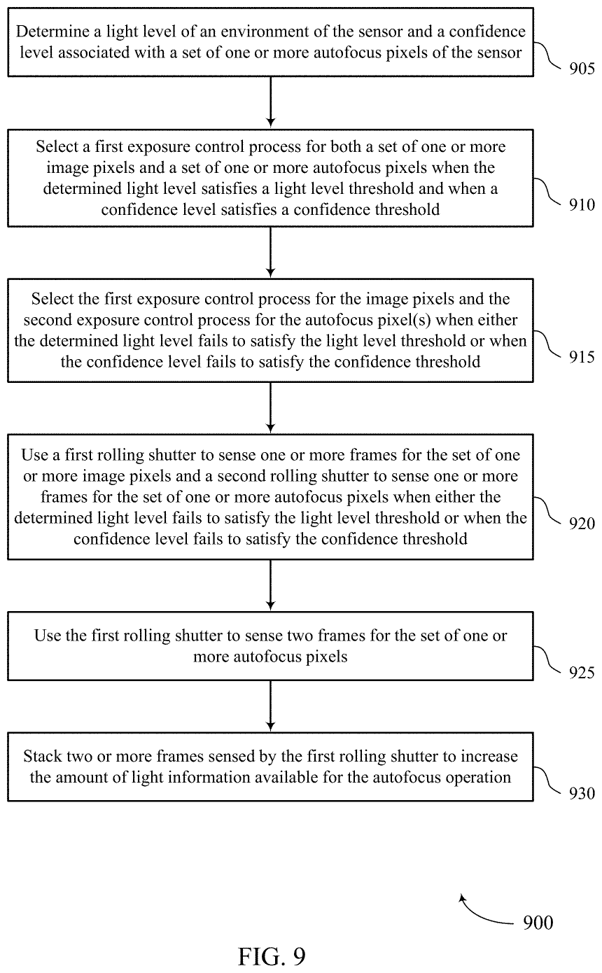

FIG. 9 shows a flowchart illustrating a method 900 that supports dynamic autofocus exposure in low light conditions in accordance with aspects of the present disclosure. The operations of method 900 may be implemented by a device or its components as described herein. For example, the operations of method 900 may be performed by an image processing manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may determine a light level of an environment of a sensor (e.g., image sensor 750) and a confidence level associated with a set of one or more autofocus pixels of the sensor. The operations of 905 may be performed according to the methods described herein. In some examples, aspects of the operations of 905 may be performed by a monitoring manager as described with reference to FIGS. 4 through 7.

At 910, the device may select a first exposure control process for both a set of one or more image pixels and a set of one or more autofocus pixels when the determined light level satisfies a light level threshold and when a confidence level satisfies a confidence level threshold. The operations of 910 may be performed according to the methods described herein. In some examples, aspects of the operations of 910 may be performed by a selection manager as described with reference to FIGS. 4 through 7.

At 915, the device may select the first exposure control process for the image pixels and the second exposure control process for the autofocus pixel(s) when either the determined light level fails to satisfy the light level threshold or when the confidence level fails to satisfy the confidence level threshold. The operations of 915 may be performed according to the methods described herein. In some examples, aspects of the operations of 915 may be performed by a selection manager as described with reference to FIGS. 4 through 7.

At 920, the device may use a first rolling shutter to sense one or more frames for the set of one or more image pixels and a second rolling shutter to sense one or more frames for the set of one or more autofocus pixels when either the determined light level fails to satisfy the light level threshold or when the confidence level fails to satisfy the confidence level threshold. The operations of 920 may be performed according to the methods described herein. In some examples, aspects of the operations of 920 may be performed by a shutter manager as described with reference to FIGS. 4 through 7.

At 925, the device may use the first rolling shutter to sense two frames for the set of one or more autofocus pixels. The operations of 925 may be performed according to the methods described herein. In some examples, aspects of the operations of 925 may be performed by a shutter manager as described with reference to FIGS. 4 through 7.

At 930, the device may stack two or more frames sensed by the first rolling shutter to increase an amount of light information available for the autofocus operation. The operations of 930 may be performed according to the methods described herein. In some examples, aspects of the operations of 930 may be performed by an image stacking manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
using a first exposure control process to set an exposure length for a set of one or more image pixels of a sensor;
determining a light level of an environment of the sensor and a confidence level associated with a set of one or more autofocus pixels of the sensor;
selecting one of the first exposure control process or a second exposure control process for the set of one or more autofocus pixels of the sensor, wherein the selection is based at least in part on the light level and the confidence level;
performing an autofocus operation for the sensor based at least in part on an output of the one or more autofocus pixels and the selected one of the first exposure control process or the second exposure control process; and
outputting image data from the one or more image pixels of the sensor based at least in part on the autofocus operation.

2. The method of claim 1, wherein the selection of the first exposure control process is based at least in part on a comparison of the light level to a light level threshold, or a comparison of the confidence level to a confidence level threshold, or both.

3. The method of claim 2, further comprising:
selecting the first exposure control process for both the set of one or more image pixels and the set of one or more autofocus pixels when the determined light level satisfies the light level threshold and when the confidence level satisfies the confidence level threshold.

4. The method of claim 2, further comprising:
selecting the first exposure control process for the one or more image pixels and the second exposure control process for the one or more autofocus pixels when either the determined light level fails to satisfy the light level threshold or when the confidence level fails to satisfy the confidence level threshold.

5. The method of claim 2, wherein satisfying the confidence level threshold is based at least in part on a signal to noise ratio (SNR) associated with the set of one or more autofocus pixels exceeding a set SNR value or a disparity between a first set of autofocus pixels from a first autofocus sensor and a second set of autofocus pixels from a second autofocus sensor being below a set disparity value, the set of one or more autofocus pixels including the first set of autofocus pixels and the second set of autofocus pixels.

6. The method of claim 2, further comprising:
using a first rolling shutter to sense one or more frames for the set of one or more image pixels and a second rolling shutter to sense one or more frames for the set of one or more autofocus pixels when either the determined light level fails to satisfy the light level threshold or when the confidence level fails to satisfy the confidence level threshold.

7. The method of claim 6, further comprising:
using the first rolling shutter to sense one or more frames for the one or more autofocus pixel(s) and sense one or more frames for the set of one or more image pixels when the determined light level satisfies the light level threshold and when the confidence level satisfies the confidence level threshold.

8. The method of claim 6, further comprising:
using the first rolling shutter to sense two frames for the set of one or more autofocus pixels.

9. The method of claim 8, further comprising:
stacking two or more frames sensed by the first rolling shutter to increase an amount of light information available for the autofocus operation.

10. The method of claim 1, wherein the autofocus operation includes a phase detection autofocus operation.

11. An apparatus for image processing, comprising:
a sensor comprising a set of one or more image pixels and a set of one or more autofocus pixels;
a processor,
memory in electronic communication with the processor; and
instructions stored in the memory and executable by the processor to cause the apparatus to:
use a first exposure control process to set an exposure length for the set of one or more image pixels of the sensor;
determine a light level of an environment of the sensor and a confidence level associated with the set of one or more autofocus pixels of the sensor;
select one of the first exposure control process or a second exposure control process for the set of one or more autofocus pixels of the sensor, wherein the selection is based at least in part on the light level and the confidence level;
perform an autofocus operation for the sensor based at least in part on an output of the one or more autofocus pixels and the selected one of the first exposure control process or the second exposure control process; and
output image data from the one or more image pixels of the sensor based at least in part on the autofocus operation.

12. The apparatus of claim 11, wherein the selection of the first exposure control process is based at least in part on a comparison of the light level to a light level threshold, or a comparison of the confidence level to a confidence level threshold, or both.

13. The apparatus of claim 12, wherein the instructions are further executable by the processor to cause the apparatus to:
select the first exposure control process for both the set of one or more image pixels and the set of one or more autofocus pixels when the determined light level satisfies the light level threshold and when the confidence level satisfies the confidence level threshold.

14. The apparatus of claim 12, wherein the instructions are further executable by the processor to cause the apparatus to:
select the first exposure control process for the one or more image pixels and the second exposure control process for the one or more autofocus pixels when either the determined light level fails to satisfy the light level threshold or when the confidence level fails to satisfy the confidence level threshold.

15. The apparatus of claim 12, wherein satisfying the confidence level threshold is based at least in part on a signal to noise ratio (SNR) associated with the set of one or more autofocus pixels exceeding a set SNR value or a disparity between a first set of autofocus pixels from a first autofocus sensor and a second set of autofocus pixels from a second autofocus sensor being below a set disparity value, the set of one or more autofocus pixels including the first set of autofocus pixels and the second set of autofocus pixels.

16. The apparatus of claim 12, wherein the instructions are further executable by the processor to cause the apparatus to:
use a first rolling shutter to sense one or more frames for the set of one or more image pixels and a second rolling shutter to sense one or more frames for the set of one or more autofocus pixels when either the determined light level fails to satisfy the light level threshold or when the confidence level fails to satisfy the confidence level threshold.

17. The apparatus of claim 16, wherein the instructions are further executable by the processor to cause the apparatus to:
use the first rolling shutter to sense one or more frames for the one or more autofocus pixels and sense one or more frames for the set of one or more image pixels when the determined light level satisfies the light level threshold and when the confidence level satisfies the confidence level threshold.

18. The apparatus of claim 16, wherein the instructions are further executable by the processor to cause the apparatus to:
use the first rolling shutter to sense two frames for the set of one or more autofocus pixels.

19. A non-transitory computer-readable medium storing code for image processing at a device, the code comprising instructions executable by a processor to:
use a first exposure control process to set an exposure length for a set of one or more image pixels of a sensor;
determine a light level of an environment of the sensor and a confidence level associated with a set of one or more autofocus pixels of the sensor;
select one of the first exposure control process or a second exposure control process for the set of one or more autofocus pixels of the sensor, wherein the selection is based at least in part on the light level and the confidence level;
perform an autofocus operation for the sensor based at least in part on an output of the one or more autofocus pixels and the selected one of the first exposure control process or the second exposure control process; and
output image data from the one or more image pixels of the sensor based at least in part on the autofocus operation.

20. The non-transitory computer-readable medium of claim 19, wherein the selection of the first exposure control process is based at least in part on a comparison of the light level to a light level threshold, or a comparison of the confidence level to a confidence level threshold, or both.
